(19) United States
(12) Patent Application Publication
(10) Pub. No.: US 2013/0125444 A1
(43) Pub. Date: May 23, 2013

(54) BALLOON DECOYS

(71) Applicant: William Emerson BOWERSOX, JR., Lewistown, PA (US)

(72) Inventor: William Emerson BOWERSOX, JR., Lewistown, PA (US)

(21) Appl. No.: 13/298,707

(22) Filed: Nov. 17, 2011

(51) Int. Cl. A01M 31/06; B23P 11/00

(52) U.S. Cl. 43/3; 43/2; 29/428

(57) ABSTRACT

Balloon decoy systems and methods of making balloon decoys to assist in hunting or capturing various species of bird are disclosed, which overcome drawbacks inherent to conventional methods of attracting birds to a desired hunting or capture area. A balloon decoy includes a first portion fused to a second portion, a valve, and a first tether attachment point disposed on an exterior surface of the second portion. A balloon decoy system includes a bird-shaped balloon decoy and a ground unit coupled via a tether. The ground unit includes a remote-controlled reel disposed within an outside shell with an opening, which can accommodate the tether. The outside shell may be painted or otherwise colored to exhibit camouflaging properties. The balloon decoy system may also include a plurality of balloon decoys coupled via tethers.

### BACKGROUND

Decoys are conventionally used in bird hunting. Hunters can affect or control the movement of birds through an area by using a decoy with an avian appearance. By attracting a group of birds to a desired area, hunters can increase their chances of success.

Additionally, decoys are often used to capture populations of birds, as in animal translocation projects, as well as in captive breeding and other ex-situ conservation efforts. Moreover, decoys have specific ornithological applications, such as duck ringing.

Conventional decoys, however, present several disadvantages. It is unmanageable for one person to hunt or capture a bird while simultaneously operating a conventional decoy; the assistance of another person is usually required. Further, the presence of a decoy operator can disrupt the proper functioning of the decoy and the predictability of the birds' behavior. Furthermore, the general setup of conventional decoys lacks realism, thereby diminishing the decoy effect necessary for successful hunting and capture.

### SUMMARY

An exemplary embodiment of the balloon decoy may include a first portion fused to a second portion, a valve, and a first tether attachment point disposed on an exterior lower surface of the balloon decoy.

Another exemplary embodiment of the balloon decoy system may include a bird-shaped balloon decoy coupled to a ground unit via a tether. The ground unit may include a remote-controlled reel disposed within an outside shell, which includes an opening to accommodate the tether. The outside shell may be painted or otherwise colored to exhibit camouflaging properties.

Yet another exemplary embodiment of the balloon decoy system may include a plurality of balloon decoys coupled to one another via tethers.

Other features of the disclosed embodiments will be apparent from the accompanying drawings and from the detailed description which follows.

### BRIEF DESCRIPTION OF THE FIGURES

The present embodiments are illustrated by way of example and not limitation in the figures of the accompanying drawings, in which like references indicate similar elements and in which:

FIG. 1a shows an isometric view of an exemplary embodiment of a balloon decoy.

FIG. 1b shows a bottom view of an exemplary embodiment of a balloon decoy.

FIG. 2a shows an top view of an exemplary embodiment of a tether attachment point.

FIG. 2b shows a isometric view of an exemplary embodiment of a tether attachment point.

FIGS. 3a and 3b show side views of an exemplary embodiment of a balloon decoy.

FIG. 4a shows an exemplary embodiment of a balloon decoy system.

FIG. 4b shows a cross-sectional view of an exemplary embodiment of a ground unit.

FIG. 5 shows an exemplary embodiment of a multiple-balloon decoy system.

### DETAILED DESCRIPTION OF TH EMBODIMENTS

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Embodiments disclosed herein describe balloon decoy systems and methods of making balloon decoys, which may be used to attract birds to a desired area for hunting or capture.

The balloon decoy may be constructed in the shape of a bird, filled with a lighter-than-air gas, such as helium, attached to a string, and subsequently released while holding the free end of the string. The balloon decoy may attract birds into a desired hunting or capture area.

The free end of the string may also be attached to a camouflaged reel, which may be remotely operated, thereby allowing one person to use it without assistance.

A second balloon decoy may be attached to the first balloon decoy, thereby simulating a bird fight or a flock of birds, which may more effectively attract other birds into a desired hunting or capture area.

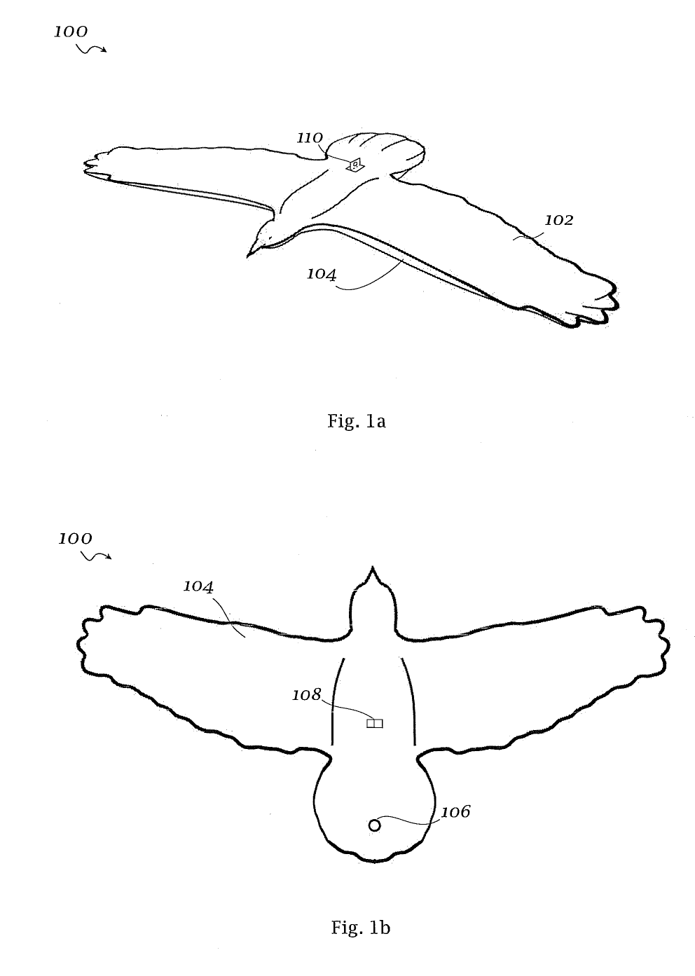

FIGS. 1a and 1b show an exemplary embodiment 100 of a balloon decoy. The balloon decoy may include a first portion 102 fused or otherwise coupled to a second portion 104. The first portion 102 and the second portion 104 may be constructed from foil, polyethylene terephthalate (“BoPET”)—as manufactured by, for example, Mylar®—or any other balloon material known in the art, and shaped and painted or otherwise colored to resemble a bird, in flight, standing, or in any other position. The finish on the balloon material may be shiny or matte.

In the exemplary embodiment 100, the first portion 102 may be fused or coupled to the second portion 104 by any fusion or attachment method known in the art.

In the exemplary embodiment 100, the balloon decoy may further include a valve 106 disposed on an exterior lower surface of the balloon decoy, a first tether attachment point 108 disposed on an exterior lower surface of the balloon decoy, and a second tether attachment point 110 disposed on an exterior upper surface of the balloon decoy. The tether attachment points 108 and 110 may include a hoop constructed from the balloon material, or any attachment means known in the art. Minimizing the distance from the tether attachment points 108 and 110 to the center of gravity of the balloon decoy may minimize the amount of tilt of the balloon decoy in flight. Alternatively, the tether attachment points 108 and 110 may be located away from the center of gravity of the balloon decoy if some tilt is desired. The valve 106 may be a resealable valve, or any valve known in the art.

In the exemplary embodiment 100, the balloon decoy may resemble a bird in flight.

In operation, the balloon decoy may be inflated through the valve 106, which may be subsequently sealed. A tether may be attached to the first tether attachment point 108 at one end and held by a user at the other end, upon which the balloon decoy may be released. The tether may be made of plastic, metal, or any other tether material known in the art.

An exemplary method of making a balloon decoy may include providing a first portion 102, a second portion 104, a valve 106, and a first tether attachment point 108, coupling the first portion and the second portion, disposing the valve on an exterior lower surface of the balloon decoy, and disposing the first tether attachment point on an exterior lower surface of the balloon decoy.

In another exemplary method of making a balloon, the step of coupling the first portion 102 and the second portion 104 may include fusing the first portion 102 and the second portion 104 by using any fusing method known in the art.

In another exemplary method of making a balloon, the step of coupling the first portion 102 and the second portion 104 may include fusing the first portion 102 to the second portion 104 by disposing the first portion 102 on the second portion 104, providing a heated element having a shape substantially similar to an outline of the first portion 102, placing the heated element on the first portion 102 until the first portion 102 is coupled to the second portion 104, and removing the heated element from the first portion 102. The heated element made be made of iron, or of any other heat-conductive material known in the art.

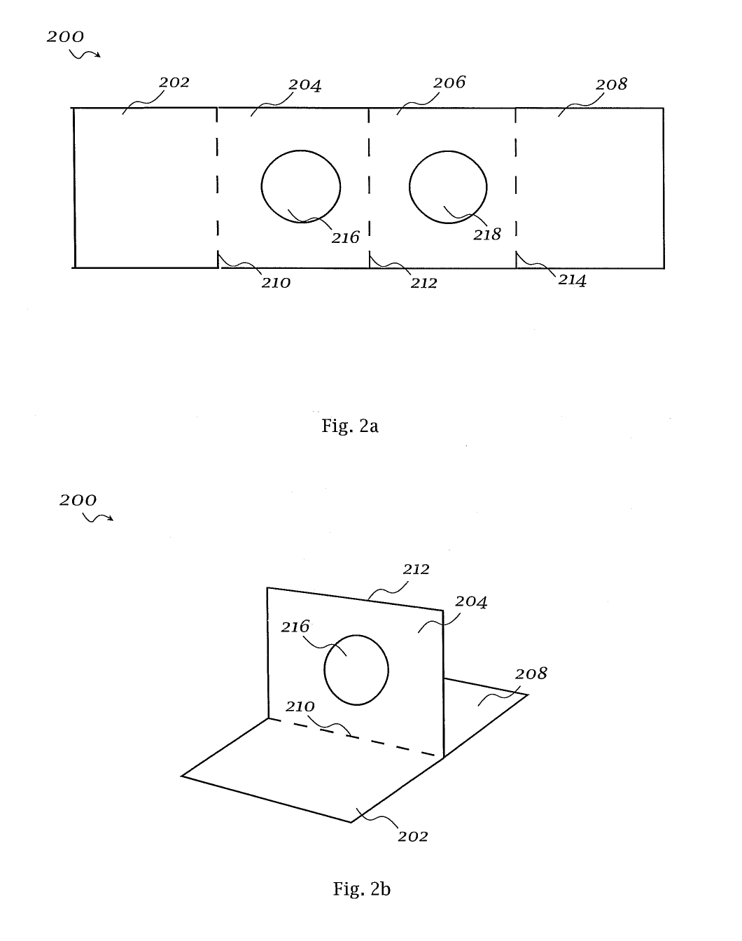

FIGS. 2a and 2b show an exemplary embodiment 200 of a tether attachment point. The tether attachment point may be an element constructed from an adhesive material, and may include subdivisions 202, 204, 206 and 208, separated by folds 210, 212 and 214. Subdivisions 204 and 206 may be punctured by eyelets 216 and 218. The tether attachment point may be constructed from an adhesive material, such that subdivisions 204 and 206 may bond to each other, and subdivisions 202 and 208 may bond to an exterior surface of a balloon decoy. Alternatively, the tether attachment point may include an adhesive element punctured by at least one eyelet, or a hoop constructed from the balloon material, or any attachment means known in the art.

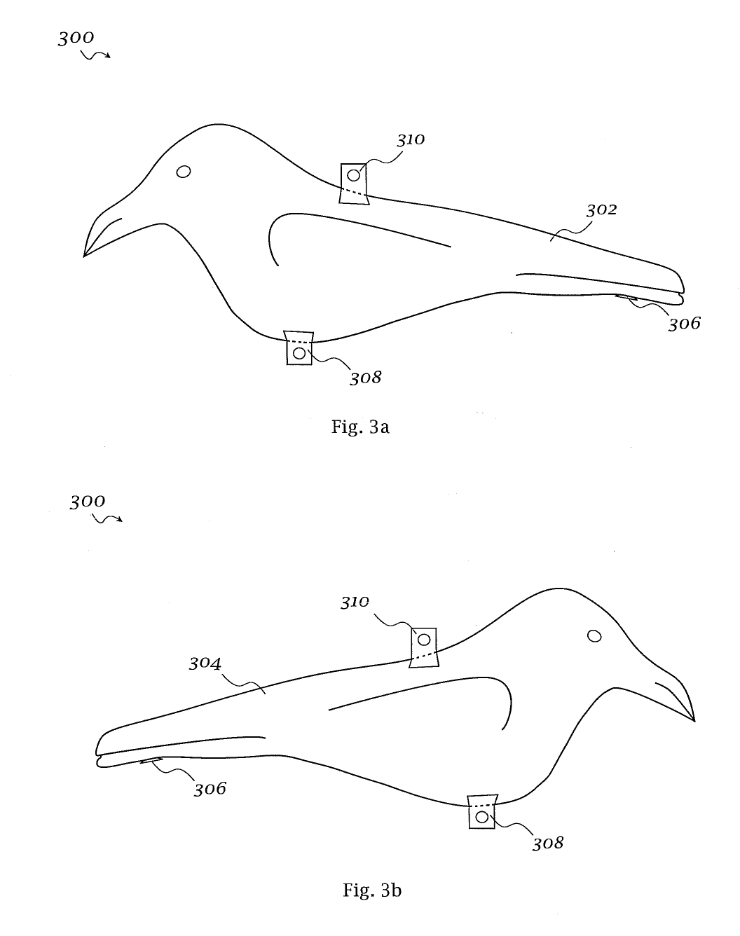

FIGS. 3a and 3b show an exemplary embodiment 300 of a balloon decoy resembling a standing bird. Many components of embodiment 300 are the same or similar to those of embodiment 100, and are identified by similar numerals. Such components should be understood to have substantially similar characteristics and functionality in both embodiments. This embodiment may include a first portion 302, a second portion 304, a valve 306, a first tether attachment point 308, and a second tether attachment point 310. This embodiment may be used as a single decoy, or in combination with other decoys, for a realistic effect.

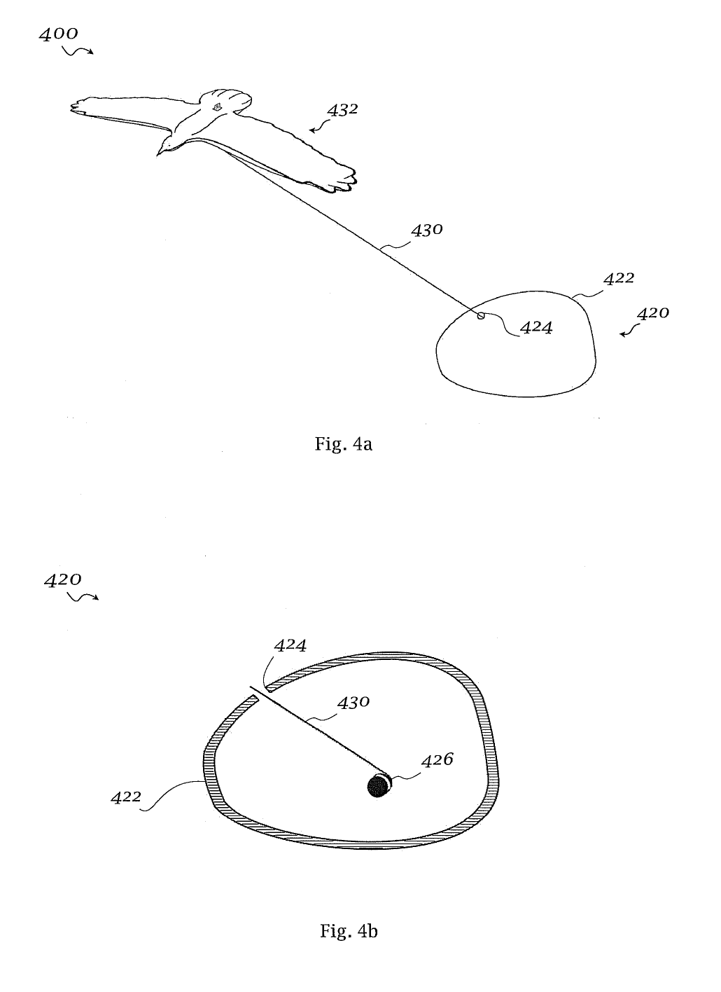

FIGS. 4a and 4b show an exemplary embodiment 400 of a balloon decoy system. Many components of embodiment 400 are the same or similar to those of embodiment 100, and are identified by similar numerals. Such components should be understood to have substantially similar characteristics and functionality in both embodiments. The balloon decoy system 400 may include a balloon decoy 432 coupled to a ground unit 420 via a tether 430. The ground unit 420 may include a reel 426 disposed within an outside shell 422, which may include an opening 424. The opening 424 in the outside shell may be large enough to accommodate the tether 430. The reel 426 may be electric and may be remote-controlled. The outside shell 422 may be constructed from plastic, wood, metal, or any other rigid or semi-rigid material known in the art. The outside shell 422 may be painted or otherwise colored to resemble a rock, grass, or any environment in which the balloon decoy system may be used, in order to exhibit effective camouflaging properties and increase the realism of the decoy. The balloon decoy 432 may be coupled to the tether 430 at its first tether attachment point.

In operation, reeling the balloon decoy 432 in and out may be accomplished remotely. The ability to remotely reel the balloon decoy 432 in and out may allow the operator to adjust the visibility of the balloon decoy without interfering with the realism of the decoy.

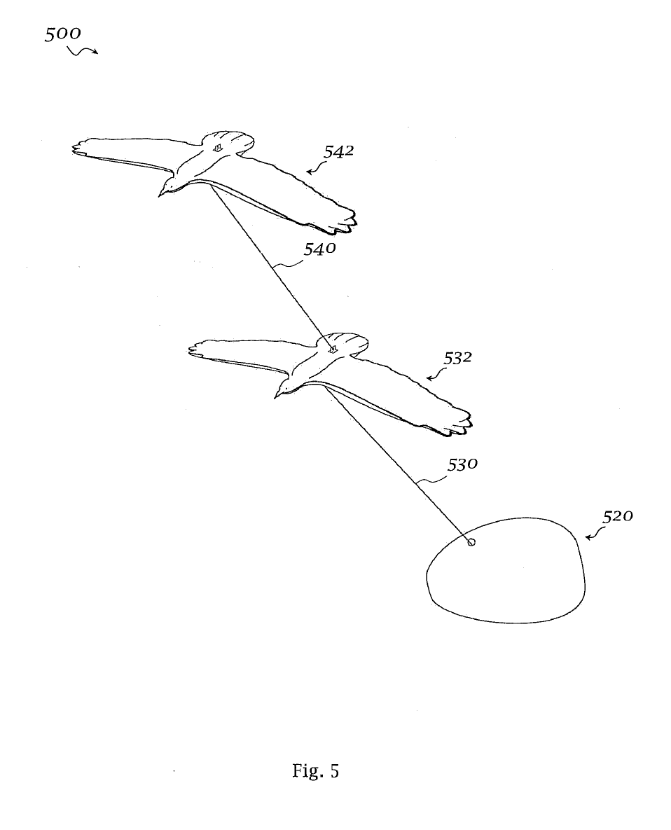

FIG. 5 shows an exemplary embodiment 500 of a multiple-balloon decoy system. Many components of embodiment 500 are the same or similar to those of embodiment 400, and are identified by similar numerals. Such components should be understood to have substantially similar characteristics and functionality in both embodiments. The balloon decoy system 500 may include a first balloon decoy 532 coupled to a ground unit 520 via a first tether 530, and coupled to a second balloon decoy 542 via a second tether 540. The first balloon decoy 532 may be coupled to the second tether 540 at its second tether attachment point. The shape and design of the second balloon decoy 542 may resemble that of the first balloon decoy 532, or may resemble a different species of bird, such as one that commonly preys on the bird represented by the first balloon decoy 532. The multiple-balloon decoy system may thus represent a flock of birds, a bird fight, or any other situation involving multiple birds, for a realistic effect.

Yet another exemplary embodiment of a multiple-balloon decoy system may include a plurality of balloon decoys, sequentially or otherwise coupled via tethers.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A balloon decoy comprising:
a first portion coupled to a second portion;
a valve disposed on an exterior lower surface of the balloon decoy; and
a first tether attachment point disposed on an exterior lower surface of the balloon decoy.

2. The balloon decoy of claim 1, wherein the valve is a resealable valve.

3. The balloon decoy of claim 1, wherein the first portion and the second portion are at least one of shaped and colored in an avian fashion.

4. The balloon decoy of claim 1, wherein the first tether attachment point is an adhesive element punctured by at least one eyelet.

5. The balloon of claim 1, further comprising a second tether attachment point disposed on an exterior upper surface of the balloon decoy.

6. The balloon decoy of claim 5, wherein the second tether attachment point is an adhesive element punctured by at least one eyelet.

7. A balloon decoy system comprising:
the balloon decoy of claim 1;
a tether; and
a ground unit, which comprises a reel disposed within an outside shell,
wherein the outside shell comprises an opening,
wherein a first end of the tether is coupled to the reel, and a second end of the tether is coupled to the balloon decoy.

8. The balloon decoy system of claim 7, wherein the valve of the balloon decoy is a resealable valve.

9. The balloon decoy system of claim 7, wherein the first portion and the second portion of the balloon decoy are at least one of shaped and colored in an avian fashion.

10. The balloon decoy system of claim 7, wherein the first end of the tether passes through the opening of the outside shell and is coupled to the reel.

11. The balloon decoy system of claim 7, wherein the second end of the tether is coupled to the first tether attachment point of the balloon decoy.

12. The balloon decoy system of claim 7, wherein the reel is one of an electric reel and a remote-controlled reel.

13. A multiple-balloon decoy system comprising:
a plurality of balloon decoys of claim 5;
a plurality of tethers; and
a ground unit, which comprises a reel disposed within an outside shell,
wherein the outside shell comprises an opening,
wherein a first end of one of the plurality of tethers is coupled to the reel, and a second end of the one of the plurality of tethers is coupled to one of the plurality of balloon decoys, and
wherein the plurality of balloon decoys are coupled to one another via the plurality of tethers.

14. The balloon decoy system of claim 13, wherein the valve of at least one of the plurality of balloon decoys is a resealable valve.

15. The balloon decoy system of claim 13, wherein the first portion and the second portion of at least one of the plurality of balloon decoys are at least one of shaped and colored in an avian fashion.

16. The balloon decoy of claim 13, wherein at least one of the first tether attachment point and the second tether attachment point of at least one of the plurality of balloon decoys of at least one of the plurality of balloon decoys is an adhesive element punctured by at least one eyelet.

17. The balloon decoy system of claim 13, wherein the reel is one of an electric reel and a remote-controlled reel.

18. The balloon decoy system of claim 13,
wherein the plurality of balloon decoys are sequentially coupled to one another via the plurality of tethers, such that:
the first end of each of the plurality of tethers is coupled to the second tether attachment point of one of the plurality of balloon decoys; and
the second end of each of the plurality of tethers is coupled to the first tether attachment point of another one of the plurality of balloon decoys.

19. A method of making a balloon decoy, comprising the steps of:
providing a first portion, a second portion, a resealable valve, and a first tether attachment point;
coupling the first portion and the second portion;
disposing the resealable valve on an exterior lower surface of the balloon decoy; and
disposing the first tether attachment point on an exterior lower surface of the balloon decoy.

20. The method of making a balloon decoy of claim 19, wherein the step of coupling the first portion and the second portion comprises:
disposing the first portion on the second portion;
providing a heated element having a shape substantially similar to an outline of the first portion;
placing the heated element on the first portion until the first portion is coupled to the second portion; and
removing the heated element from the first portion.
